(19) United States
(12) Patent Application Publication
(10) Pub. No.: US 2017/0037934 A1
(43) Pub. Date: Feb. 9, 2017

(54) CHAIN

(71) Applicant: TSUBAKIMOTO CHAIN CO., Osaka-shi, Osaka (JP)

(72) Inventors: Aiko Arima, Osaka-shi (JP); Yuji Fukuike, Osaka-shi (JP)

(73) Assignee: TSUBAKIMOTO CHAIN CO., Osaka-shi, Osaka (JP)

(21) Appl. No.: 15/305,566

(22) PCT Filed: Feb. 17, 2015
(86) PCT No.: PCT/JP2015/054251

§ 371 Date: Oct. 20, 2016

(30) Foreign Application Priority Data
Apr. 25, 2014 (JP) 2014-091802

(51) Int. Cl. F16G 13/02; C09D 7/12; C23F 11/18; C09D 163/00; C09D 133/00; F16G 13/06; C09D 5/10; C09D 175/04

(52) U.S. Cl. CPC F16G 13/02; C09D 5/106; C09D 7/1216; C09D 175/04; C09D 163/00; C09D 133/00; F16G 13/06; C23F 11/182

(57) ABSTRACT

A chain is provided in which a paint film has satisfactory adhesiveness and uniformity so that the satisfactory rust prevention property is maintained for a long period of time. A chain includes inner plates, bushes, outer plates, connecting pins, and rollers. Each constituent component includes: a zinc-aluminum-magnesium alloy coating layer formed on an iron-based basis material by impact plating; and a paint film formed on the zinc-aluminum-magnesium alloy coating layer by employing a water-based anti-corrosive paint which contains zinc, barium sulfate and colloidal silica.

### FIELD OF THE INVENTION

The present invention relates to a chain such as a bush chain and a roller chain which is used in a corrosive atmosphere of salt water, or the like and in which a zinc-aluminum-magnesium alloy coating layer is formed on the surface and then a paint film is formed on the zinc-aluminum-magnesium alloy coating layer by employing a paint containing zinc.

### BACKGROUND OF THE INVENTION

In the conventional art, for the purpose of corrosion protection of a chain used in a corrosive atmosphere of salt water or the like, the iron-based basis material surface of each component of the chain is coated with a metal such as zinc which is baser than iron or, alternatively, with a metal such as nickel nobler than iron. The former kind of method, i.e., zinc plating, includes electro zinc plating and powder-impact zinc plating. The latter kind of method, i.e., nickel plating, includes electro nickel plating and electroless nickel plating.

Further, in some cases, the sacrificial protection action of zinc and aluminum (the action in which such a metal has a higher ionization tendency than iron and hence is eluted before iron elution so as to suppress iron corrosion) is employed so that a paint film is formed on the surface of an iron-based basis material of each component of the chain by employing a water-based anti-corrosive paint containing zinc, aluminum, and the like as metal pigments.

Patent Document 1 discloses an invention of a component for anti-corrosive chain constructed such that a zinc coating layer is formed on an iron basis material in a non-hydrogen atmosphere and then a water-based anti-corrosive paint containing aluminum powder and silicone resin is bake-coated on the zinc coating layer so that a white-rust preventing bake-coated film is formed.

Patent Document 2 discloses an invention of a chain constructed such that a blasting material composed of zinc-iron alloy is projected onto an iron basis material so that a zinc-iron alloy underlying coating layer is formed and then a water-based anti-corrosive paint containing base metal powder composed mainly of zinc, an organic compound containing a mercapto group and coating the base metal powder, and a nitrate is applied onto the zinc-iron alloy underlying coating layer so that a paint film is formed.

### PRIOR ART REFERENCES

### Patent Documents

[Patent Document 1] Japanese Patent No. 3122037

[Patent Document 2] Japanese Patent No. 4869349

### SUMMARY OF THE INVENTION

### Problems to be Solved by the Invention

However, when the chain constituent components having undergone corrosion protection are to be assembled, at the time that a bush is press-fit to the inner plates and a connecting pin is press-fit to the outer plates, paint film spalling easily occurs in the tightened rivet part. Thus, rusting easily begins starting from this position at an early stage. Accordingly, repair has been required after assembling of the chain.

Further, the water-based anti-corrosive paint of Patent Document 2 has satisfactory storage stability and the chain also has a satisfactory rust prevention property. However, it is required that satisfactory rust prevention property is maintained for a longer period of time.

The present invention has been devised in view of such situations. An object thereof is to provide a chain in which a paint film has satisfactory adhesiveness, and high uniformity of the constituent and thickness so that the satisfactory rust prevention property is maintained for a long period of time.

### Means for Solving the Problem

As a result of earnest research, the present inventors have found that a zinc-aluminum-magnesium alloy coating layer is formed on the surface of an iron-based basis material of a chain, and then a water-based anti-corrosive paint containing zinc, barium sulfate and colloidal silica is applied on the zinc-aluminum-magnesium alloy coating layer to form a paint film, so that satisfactory rust prevention property is imparted to the chain and the rust prevention property is maintained for a long period of time. As such, the present invention has been achieved.

That is, a chain according to a first embodiment of the present invention is fabricated from an iron-based material, and constructed by alternately linking a pair of outer plates and a pair of inner plates, and comprises: a zinc-aluminum-magnesium alloy coating layer formed on a surface; and a paint film formed on the zinc-aluminum-magnesium alloy coating layer by employing a water-based anti-corrosive paint which contains zinc, barium sulfate and colloidal silica.

In the chain according to a second embodiment of the present invention, based on the first embodiment, a mass ratio of the barium sulfate to the zinc is 0.15 or higher and 7 or lower.

In the chain according to a third embodiment of the present invention, based on the first or second embodiment, a mass ratio of a solid content of the colloidal silica to a total mass of the zinc and the barium sulfate is 0.01 or higher and 0.08 or lower.

A chain according to a fourth embodiment of the present invention is fabricated from an iron-based material, and constructed by alternately linking a pair of outer plates and a pair of inner plates, and comprises: a zinc-aluminum-magnesium alloy coating layer formed on a surface; and a paint film formed on the zinc-aluminum-magnesium alloy coating layer by employing a water-based anti-corrosive paint which contains zinc and barium sulfate, and in which a mass ratio of the barium sulfate to the zinc is 1.1 or higher and 7 or lower.

A chain according to a fifth embodiment of the present invention is fabricated from an iron-based material, and constructed by alternately linking a pair of outer plates and a pair of inner plates, and comprises: a zinc-aluminum-magnesium alloy coating layer formed on a surface; and a paint film formed on the zinc-aluminum-magnesium alloy coating layer by employing a water-based anti-corrosive paint which contains zinc and colloidal silica, and in which a mass ratio of a solid content of the colloidal silica to the zinc is 0.04 or higher and 0.08 or lower.

In the chain according to a sixth embodiment of the present invention, based on any one of the first to fifth embodiments, the paint film is obtained by at least one kind of resin selected from a group consisting of urethane resin, epoxy resin, and acrylic resin having been hardened, and a mass ratio of a total mass of the zinc, and the barium sulfate and/or a solid content of the colloidal silica to an entire mass obtained as a sum of the total mass and a mass of a solid content of the resin having been hardened is 0.45 or higher and 0.7 or lower.

Here, in a case that the first to third embodiments are cited, “a total mass of the zinc, and the barium sulfate and/or a solid content of the colloidal silica” means a total mass of “the zinc+the barium sulfate+the solid content of the colloidal silica”. In a case that the fourth embodiment is cited, it means a total mass of “the zinc+the barium sulfate”. In a case that the fifth embodiment is cited, it means a total mass of “the zinc+the solid content of the colloidal silica”.

In the chain according to an seventh embodiment of the present invention, based on any one of the first to sixth embodiments, the water-based anti-corrosive paint further contains: a silane compound whose molecule includes an alkyl group, a phenyl group, or a halo-alkyl group obtained by replacing a part or all of hydrogen atoms with halogen atoms, and a hydrolytic silicon group; and at least one kind of surfactant selected from a group consisting of polyoxyethylene alkylamine, polyoxyethylene alkyl ether, polyoxyethylene distyrenated phenyl ether, sorbitan fatty acid ester, polyoxyethylene sorbitan fatty acid ester, and alkyl ether phosphate salt.

In the chain according to an eighth embodiment of the present invention, based on the seventh embodiment, a mass ratio of the silane compound to the zinc is 0.005 or higher and 0.8 or lower.

In the chain according to a ninth embodiment of the present invention, based on the seventh or eighth embodiment, a mass ratio of the surfactant to the zinc is 0.005 or higher and 0.8 or lower.

In the chain according to a tenth embodiment of the present invention, based on any one of the seventh to ninth embodiments, the water-based anti-corrosive paint further contains a silane coupling agent whose molecule includes: at least one functional group selected from a group consisting of an epoxy group, a methacryloxy group, an acryloxy group, an amino group, and a vinyl group; and a hydrolytic silicon group.

In the chain according to an eleventh embodiment of the present invention, based on the tenth embodiment, a mass ratio of the silane coupling agent to the zinc is 0.005 or higher and 1 or lower.

In the embodiment, an alloy coating layer containing zinc, aluminum, and magnesium which have ionization tendencies higher than iron and hence are eluted faster than iron is formed on the surface of the iron-based basis material of the chain. Thus, corrosion of the iron is suppressed satisfactorily. Further, since the paint film is formed on the alloy coating layer by employing the water-based anti-corrosive paint containing zinc, sacrificial protection action of zinc works satisfactorily. Since the paint film contains barium sulfate, the paint film strength and the adhesiveness become satisfactory. Since the paint film contains colloidal silica, the sacrificial protection action is maintained for a long period of time and the rust prevention property is improved. In the chain according to the embodiment, the adhesiveness of the paint film is satisfactory and the paint film has high strength and high uniformity. Accordingly, at the time of assembling and usage, generation of paint film powder is suppressed and repair after assembling is not required. Further, the satisfactory rust prevention property is maintained. That is, the bending failure and the roller rotation failure which are caused by red rust can be suppressed for a long period of time, and durability of the chain is improved.

In a case that the water-based anti-corrosive paint contains a silane compound and a surfactant, the surfactant causes the silane compound to be affinitive to water so that hydrolysis easily occurs and then the zinc is bonded to the silanol group generated by the hydrolysis so as to be satisfactorily dispersed and stabilized in the paint. Thus, the paint is easily hardened at the time of baking and the paint film is more uniformly formed on the chain.

### Effect of the Invention

The water-based anti-corrosive paint applied to the chain of the present invention has satisfactory storage stability.

According to the chain of the present invention, a zinc-aluminum-magnesium alloy coating layer is formed on the surface of the iron-based basis material of the chain, and then a water-based anti-corrosive paint containing zinc and barium sulfate and/or colloidal silica is applied on the zinc-aluminum-magnesium alloy coating layer to form a paint film. Thus, the adhesiveness of the paint film is satisfactory. Further, satisfactory rust prevention property is maintained for a long period of time. Accordingly, the bending failure and the roller rotation failure which are caused by red rust can be suppressed for a long period of time and durability of the chain is satisfactory.

### BRIEF DESCRIPTION OF THE DRAWINGS

FIG. 1 is a sectional view illustrating a chain according to an example of the present invention.

FIG. 2 is an enlarged sectional view illustrating the surface of a part of a chain of FIG. 1.

### MODE OF IMPLEMENTING THE INVENTION

An example of the chain according to the present invention is a bush chain constructed from an iron-based material and including: a pair of inner plates arranged in a manner of being separated from each other; a bush press-fit into bush press-fitting holes of the inner plates; a pair of outer plates arranged on the outer sides of the inner plates and linked to the inner plates in the forward and rearward directions; and a connecting pin press-fit into pin press-fitting holes of the outer plates in a manner of being loosely fit to the inner peripheral surface of the bush. Further, the present invention may be applied to a roller chain constructed such that a roller is further fit loosely to the outer peripheral surfaces of the connecting pin and the bush.

Employable detailed shapes for the inner plate and the outer plate in the chain of the present invention include an elliptical plate and a gourd-shaped plate.

The surface of the above-described constituent component of the chain of the present invention is provided with a zinc-aluminum-magnesium alloy coating layer (a Zn—Al—Mg alloy coating layer). The Zn—Al—Mg alloy coating layer is formed by projecting a blasting material containing Zn—Al—Mg alloy onto the surface by impact plating by using a projection apparatus for mechanical plating or the like.

Employable ranges of the composition of the alloy are Al: 1 to 5 mass %, Mg: 5.5 to 15 mass %, and Zn: remaining part. An example of the composition of the blasting material is Al: 3 mass %, Mg: 6 mass %, and Zn and impurities: 91 mass %.

The chain according to the present invention includes a first paint film formed on the Zn—Al—Mg alloy coating layer by employing a water-based anti-corrosive paint.

The water-based anti-corrosive paint contains zinc, barium sulfate and colloidal silica. As the employed barium sulfate, precipitated barium sulfate is preferable.

It is preferable that the zinc is in a powder form. Further, a flake form is more preferable. When a flake form is employed, the specific surface area increases and hence contact of metal powder to each other becomes dense. Thus, in addition to the active anti-corrosiveness of the metal itself, a protection barrier effect (passive anti-corrosiveness) based on the flake form is also obtained. This suppress occurrence of cracks in the paint film.

Further, the zinc may be made into a slurry form by using a water-soluble solvent. Employable water-soluble solvents include a glycol solvent such as propylene glycol and ethylene glycol, an alcoholic solvent such as ethanol and isopropanol, and a glycol ether solvent such as dipropylene glycol monomethyl ether.

In addition to the zinc, the water-based anti-corrosive paint may contain aluminum powder or a powder-form alloy containing: zinc; and aluminum, magnesium, tin, cobalt, manganese, or the like.

It is preferable that the mass ratio of barium sulfate to zinc (BaSO₄/Zn) is 0.15 or higher and 7 or lower. In this case, since the paint film strength and the adhesiveness are satisfactory, the rust prevention property is maintained satisfactorily, and the concealment property is satisfactory. The lower limit of BaSO₄/Zn is more preferably 0.3, still more preferably 0.7, remarkably preferably 1.1, and most preferably 1.5. The upper limit of BaSO₄/Zn is more preferably 6.

It is preferable that the mass ratio of the solid content of the colloidal silica to the total mass of zinc and barium sulfate [(solid content of colloidal silica)/(Zn+BaSO₄)] is 0.01 or higher and 0.08 or lower. In this case, the film formation property is satisfactory and the rust prevention property is maintained satisfactorily. It is confirmed through an experiment that when the mass ratio exceeds 0.08, the concealment property and adhesiveness are somewhat degraded. The lower limit of (solid content of colloidal silica)/(Zn+BaSO₄) is more preferably 0.02, still more preferably 0.03, remarkably preferably 0.04, and most preferably 0.05. The upper limit of (solid content of colloidal silica)/(Zn+BaSO₄) is more preferably 0.07.

The water-based anti-corrosive paint may contain barium sulfate alone of barium sulfate and colloidal silica. Here, (BaSO₄/Zn) is 1.1 or higher and 7 or lower. In this case, the rust prevention property is maintained satisfactorily and the concealment property is satisfactory. The lower limit of (BaSO₄/Zn) is more preferably 1.5. The upper limit of (BaSO₄/Zn) is more preferably 6.

The water-based anti-corrosive paint may contain colloidal silica alone of barium sulfate and colloidal silica. In this case, (solid content of colloidal silica)/(Zn) is 0.04 or higher and 0.08 or lower. Here, the rust prevention property is satisfactory and the concealment property is satisfactory. The lower limit of (solid content of colloidal silica)/(Zn) is more preferably 0.05, and still more preferably 0.06. The upper limit of (solid content of colloidal silica)/(Zn) is more preferably 0.07.

The water-based anti-corrosive paint contains such a component that when the paint is applied and baked on the Zn—Al—Mg alloy coating layer, at least one kind of resin selected from a group consisting of urethane resin, epoxy resin, and acrylic resin is hardened so that a first paint film is formed.

In a case that a urethane resin is hardened so that the first paint film is formed, the water-based anti-corrosive paint contains a polyisocyanate compound and a polyol compound.

Employable polyisocyanate compounds include polyisocyanate compounds described in Japanese Patent Application Laid-Open Publication No. 2014-25062. Specifically, such compounds include: an aliphatic polyisocyanate such as hexamethylene diisocyanate, trimethylhexamethylene diisocyanate, dimer acid diisocyanate, and lysine diisocyanate; a biuret type adduct, an isocyanurate ring adduct, an allophanate type adduct, and a uretdione type adduct of the aliphatic polyisocyanate; an alicyclic diisocyanate such as isophorone diisocyanate, 4,4′-methylene bis(cyclohexyl isocyanate), and methylcyclohexane-2,4- or -2,6-diisocyanate; a biuret type adduct and an isocyanurate ring adduct of the alicyclic diisocyanate; an aromatic diisocyanate compound such as xylylene diisocyanate, tetramethyl xylylene diisocyanate, tolylene diisocyanate, 4,4′-diphenylmethane diisocyanate (MDI), 1,5-naphthalene diisocyanate, and 1,4-naphthalene diisocyanate; a biuret type adduct and an isocyanurate ring adduct of aromatic diisocyanate; hydrogenerated MDI and a derivative of hydrogenerated MDI; a urethanated adduct obtained by a reaction of a polyisocyanate compound with the hydroxyl group of a polyol such as ethylene glycol, propylene glycol, 1,4-butylene glycol, dimethylol propionic acid, polyalkylene glycol, trimethylolpropane, and hexanetriol at a ratio where the isocyanate group is excessive; and a biuret type adduct or an isocyanurate ring adduct of the urethanated adduct.

The employed polyisocyanate compound may be a blocked polyisocyanate compound obtained by adding a blocking agent to the isocyanate group of the above-described polyisocyanate compound. Employable blocking agents include a blocking agent composed of phenol, lactam, alcohol, ether, oxime, active methylene, mercaptan, acid amide, imide, amine, imidazole, pyrazole, or the like.

Employable polyol compounds include epoxy resins described in Japanese Patent Application Laid-Open Publication No. 2014-19752. Specifically, such compounds include polyester polyol, acrylic polyol, polyether polyol, polyolefin polyol, fluorine polyol, and polycarbonate polyol.

Employable polyester polyol includes: a polyester polyol obtained by a condensation reaction between a dibasic acid and a polyhydric alcohol; and a polycaprolactone obtained by ring opening polymerization of ε-caprolactone performed by employing a polyhydric alcohol or the like.

Employable acrylic polyols include a copolymer between: a single compound or a mixture of ethylenic-unsaturated-bond containing monomers having a hydroxyl group; and a single compound or a mixture of other ethylenic-unsaturated-bond containing monomers allowed to be copolymerized with the above-described one.

Employable polyether polyol includes: a polyether polyol obtained by adding a single compound or a mixture of alkylene oxides to a single compound or a mixture of polyvalent hydroxy compounds under the presence of a strongly basic catalyst; a polyether polyol obtained by a reaction of a multifunctional compound such as an ethylenediamine with an alkylene oxide; and a so-called polymer polyol obtained by polymerization of an acrylamide or the like by employing the above-described polyether as a medium.

Employable polyolefin polyols include polybutadiene, hydrogenated polybutadiene, polyisoprene, and hydrogenated polyisoprene having two or more hydroxyl groups.

Employable fluorine polyols include a polyol the molecule of which contains fluorine and an example of which is a copolymer of fluoroolefin, cyclo vinyl ether, hydroxyalkyl vinyl ether, monocarboxylic acid vinyl ester, or the like disclosed in Japanese Patent Application Laid-Open Publications No. S57-34107 and No. S61-275311.

Employable polycarbonate polyols include one obtained by condensation polymerization between a low-molecular-weight carbonate compound and a polyhydric alcohol.

The above-described water-based anti-corrosive paint containing a polyisocyanate compound and a polyol compound is applied on a chain. Then, at the time of baking, the isocyanate group of the polyisocyanate compound and the active hydrogen of the polyol compound react with each other so that hardening occurs. When the blocked polyisocyanate compound is employed, the blocking agent is dissociated and then the isocyanate group having been bonded to the blocking agent reacts with the active hydrogen.

Here, in place of the approach that the polyisocyanate compound and the polyol compound are mixed into the water-based anti-corrosive paint, a urethane resin may be mixed into the water-based anti-corrosive paint from the beginning.

In a case that an epoxy resin is hardened so that the first paint film is formed, the water-based anti-corrosive paint contains the epoxy resin and a curing agent.

Employable epoxy resins include epoxy resins described in Japanese Patent Application Laid-Open Publication No. 2014-19752. Specifically, employable epoxy resins include a novolak type epoxy resin, a glycidyl ether type epoxy resin, a glycol ether type epoxy resin, an epoxy type resin of aliphatic unsaturated compound, an epoxy type fatty acid ester, a polyvalent carboxylate type epoxy resin, an amino glycidyl type epoxy resin, a β-methylepichloro type epoxy resin, a cyclic oxirane type epoxy resin, a halogen type epoxy resin, and a resorcinol type epoxy resin.

Employable curing agents include a curing agent described in Japanese Patent No. 5071602. Specifically, such agents include amine compounds, amide compounds, acid anhydride compounds, and phenol compounds.

Employable amine compounds include diaminodiphenylmethane, diethylenetriamine, triethylenetetramine, diaminodiphenyl sulfone, isophorone diamine, imidazole, a BF₃ amine complex, and a guanidine derivative.

Employable amide compounds include: dicyandiamide; and a polyamide resin synthesized from linolenic acid dimer and ethylenediamine.

Employable acid anhydride compounds include phthalic anhydride, trimellitic anhydride, pyromellitic dianhydride, maleic anhydride, tetrahydrophthalic anhydride, methyl cyclohexene-dicarboxylic anhydride, anhydrous methyl nadic acid, hexahydrophthalic anhydride, and methyl hexahydrophthalic anhydride.

Employable phenol compounds include a polyhydric phenol compound such as phenol novolak resin, cresol novolak resin, aromatic hydrocarbon formaldehyde resin, modified phenol resin, dicyclopentadiene phenol addition type resin, phenol aralkyl resin, naphthol aralkyl resin, trimethylolmethane resin, tetra phenilol ethane resin, naphthol novolak resin, naphthol phenol condensation-copolymerized novolak resin, naphthol cresol condensation-copolymerized novolak resin, biphenyl modified phenol resin, biphenyl modified naphthol resin, aminotriazine modified phenol resin, and alkoxy-group-containing aromatic-ring-modified novolak resin.

Further, the employed curing agent may be the polyisocyanate compound or the blocked polyisocyanate compound described above.

The water-based anti-corrosive paint containing the epoxy resin and the curing agent described above is applied on a chain and then baking is performed. By virtue of this, the epoxy resin is hardened.

In a case that an acrylic resin is hardened so that the first paint film is formed, the water-based anti-corrosive paint contains the acrylic resin.

The acrylic resin is obtained by emulsion polymerization of monomers composed mainly of acrylic monomers performed in an aqueous system by using an emulsifier. The acrylic monomer is a monomer having a (meta)acrylic group. As the monomer employed as the main component, a monomer not containing an active hydrogen group is preferable. On the other hand, for the purpose of stabilization of the emulsion polymerization, it is preferable that a monomer having a hydrophilic group (such as a hydroxyl group, a carboxyl group, and an ether group) is employed together.

Employable acrylic monomers include the following monomers described in Japanese Patent No. 5397946.

Among (meta)acrylic monomers, examples of (meta)acrylic acid alkyl esters include methyl (meta)acrylate, ethyl (meta)acrylate, propyl (meta)acrylate, isopropyl (meta)acrylate, butyl (meta)acrylate, isobutyl (meta)acrylate, s-butyl (meta)acrylate, t-butyl (meta)acrylate, pentyl (meta)acrylate, s-pentyl (meta)acrylate, 1-ethylpropyl (meta)acrylate, 2-methylbutyl (meta)acrylate, isopentyl (meta)acrylate, t-pentyl (meta)acrylate, 3-methylbutyl (meta)acrylate, neopentyl (meta)acrylate, hexyl (meta)acrylate, 2-methylpentyl (meta)acrylate, 4-methylpentyl (meta)acrylate, 2-ethylbutyl (meta)acrylate, cyclopentyl (meta)acrylate, cyclohexyl (meta)acrylate, heptyl (meta)acrylate, 2-heptyl (meta)acrylate, 3-heptyl (meta)acrylate, octyl (meta)acrylate, 2-octyl (meta)acrylate, 2-ethylhexyl (meta)acrylate, isooctyl (meta)acrylate, nonyl (meta)acrylate, 3,3,5-trimethylhexyl (meta)acrylate, decyl (meta)acrylate, undecyl (meta)acrylate, lauryl (meta)acrylate, cetyl (meta)acrylate, stearyl (meta)acrylate, eicosyl (meta)acrylate, docosyl (meta)acrylate, tetracosyl (meta)acrylate, methylcyclohexyl (meta)acrylate, isobornyl (meta)acrylate, norbornyl (meta)acrylate, benzyl (meta)acrylate, and phenethyl (meta)acrylate. Among these, a (meta)acrylic acid alkyl ester whose alkyl group has 1 to 24 carbon atoms is preferable.

As the monomer having a hydrophilic group, the following monomers are employable. Employable monomers having a carboxyl group include acrylic acid, methacrylic acid, itaconic acid, crotonic acid, maleic acid, fumaric acid, and 2-acryloyloxy propionic acid.

Employable monomers having a hydroxyl group include a hydroxyl-group containing (meta)acryl monomer such as hydroxyl ethyl (meta)acrylate, 2-hydroxyisopropyl (meta)acrylate, hydroxybutyl (meta)acrylate, ethylene glycol mono-(meta)acrylate, glycerol mono-(meta)acrylate, polyethylene glycol mono-(meta)acrylate, and polypropylene glycol mono-(meta)acrylate.

Employable ether-group containing monomers include glycerol monoallyl ether, trimethylolpropane monoallyl ether, and allyl alcohol.

Further, the polymerization may be performed in a state that other monomers having a polymerizable double bond are contained together with the (meta)acrylic monomer. Employable such other monomers include an ester-group containing vinyl monomer, a styrene derivative, and a vinyl ether monomer.

It is preferable that when the paint film is formed, a mass ratio of a total mass of the zinc, and the barium sulfate and/or the solid content of the colloidal silica to an entire mass obtained as a sum of the total mass and a mass of a solid content of the resin having been hardened [PWC:(Zn+BaSO₄ and/or the solid content of the colloidal silica)/(Zn+BaSO₄ and/or the solid content of the colloidal silica+the solid content of the resin)] is 0.45 or higher and 0.7 or lower. In this case, the intrusion of corrosive factors is prevented by the resin and the adhesiveness and the rust prevention property are satisfactory. The lower limit of the mass ratio is more preferably 0.48, still more preferably 0.5, remarkably preferably 0.53, and most preferably 0.55. The upper limit of the mass ratio is more preferably 0.68.

The water-based anti-corrosive paint may contain a silane compound.

In the silane compound, it is preferable that the molecule includes: an alkyl group, a phenyl group, or a halo-alkyl group obtained by replacing a part or all of hydrogen atoms with halogen atoms; and a hydrolytic silicon group.

Employable hydrolytic silicon groups are not limited to a particular one. However, from the perspective of handling property, an alkoxysilyl group is preferable. Then, from the perspective of reactivity, a methoxysilyl group and an ethoxysilyl group are remarkably preferable.

Employable silane compounds include methyl trimethoxysilane, dimethyl dimethoxysilane, phenyl trimethoxysilane, methyl triethoxysilane, dimethyl diethoxysilane, phenyl triethoxysilane, hexyl trimethoxysilane, hexyl triethoxysilane, decyl trimethoxysilane, and trifluoropropyl trimethoxysilane.

The silane compound is easily hydrolyzed and generates a silanol group. Then, the silanol group is bonded to zinc and hence the zinc is satisfactorily dispersed and stabilized in the paint. At the time of formation of the paint film, the silanol group is bonded also to the lower layer paint film and hence adhesiveness between the paint films is also improved.

From the perspectives of expression of this effect, the in-water dispersibility and stability of the paint, and the storage stability, it is preferable that the mass ratio of the silane compound to zinc (the solid content: in a case that the zinc is prepared in the form of zinc paste, the content of zinc in the zinc paste is to be adopted) is 0.005 or higher and 0.8 or lower. The lower limit of the mass ratio is more preferably 0.02 and still more preferably 0.04. Further, the upper limit of the mass ratio is more preferably 0.6.

This silane compound is different from a later-described silane coupling agent whose molecule includes: at least one functional group selected from a group consisting of an epoxy group, a methacryloxy group, an acryloxy group, an amino group, a mercapto group, and a vinyl group; and a hydrolytic silicon group. That is, the silane compound does not include a functional group and hence gelling of the paint is suppressed.

The water-based anti-corrosive paint may contain a surfactant.

It is preferable that the surfactant is at least one kind selected from a group consisting of polyoxyethylene alkylamine, polyoxyethylene alkyl ether, polyoxyethylene distyrenated phenyl ether, polyoxyethylene sorbitan fatty acid ester, sorbitan fatty acid ester, and alkyl ether phosphate salt.

The polyoxyethylene alkylamine is expressed by a general formula as in the following formula (1).

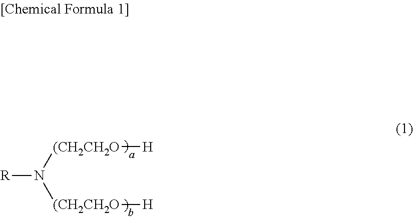

Here, a=1, 2, . . . .
b=1, 2, . . . .
R=CₙH₂₊₁
   n=1, 2, . . . .

The polyoxyethylene alkyl ether is expressed by a general formula as in the following formula (2).

RO—(CH₂CH₂O)ₙ—H (2)
n=1, 2, . . . .
R=CₘH₂ₘ₊₁
   m=1, 2, . . . .

The polyoxyethylene distyrenated phenyl ether is expressed by a general formula as in the following formula (3).

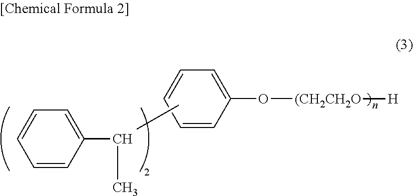

Here, n=1, 2, . . . .

The polyoxyethylene sorbitan fatty acid ester is expressed by a general formula as in the following formula (4).

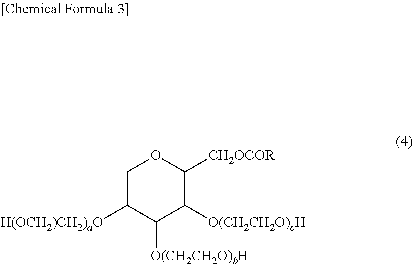

Here, a=1, 2, . . . .
b=1, 2, . . . .
c=1, 2, . . . .
R=CₙH₂ₙ₊₁
   n=1, 2, . . .

The sorbitan fatty acid ester is expressed by a general formula as in the following formula (5).

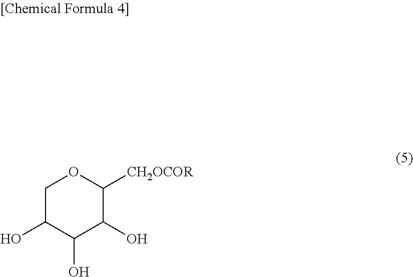

Here, R=CₙH₂ₙ₊₁
n=1, 2, . . . .

When the surfactant is contained, the silane compound easily becomes affinitive to water and hence hydrolysis of the silane compound is accelerated. Then, the generated silanol group is bonded to zinc. Thus, the zinc is satisfactorily dispersed in the water-based anti-corrosive paint so that the storage stability is improved. Since the zinc is satisfactorily dispersed and stabilized in the paint, the paint is easily hardened at the time of baking and, at the same time, a paint film having a uniform composition and a uniform thickness is allowed to be formed without a loss.

When the types and the combination of the surfactants are to be determined, HLB is taken into consideration. However, a preferable range of HLB varies depending on the types and the combination of the surfactants. Thus, surfactants are selected such as to have HLB in accordance with the types and the combination of the surfactants.

From the perspectives of the in-water dispersibility and stability of the paint and the storage stability, it is preferable that the mass ratio of the surfactants to zinc (the solid content: in a case that the zinc is prepared in the form of zinc paste, the content of zinc in the zinc paste is to be adopted) is 0.005 or higher and 0.8 or lower. The lower limit of the mass ratio is more preferably 0.02 and still more preferably 0.04. Further, the upper limit of the mass ratio is more preferably 0.6.

The water-based anti-corrosive paint may contain a silane coupling agent whose molecule includes: at least one functional group selected from a group consisting of an epoxy group, a methacryloxy group, an acryloxy group, an amino group, and a vinyl group; and a hydrolytic silicon group. Employable hydrolytic silicon groups are not limited to a particular one. However, from the perspective of handling property, an alkoxysilyl group is preferable. Then, from the perspective of reactivity, a methoxysilyl group and an ethoxysilyl group are remarkably preferable.

Employable silane coupling agents, in a case that the epoxy group is included as a functional group, include 2-(3,4-epoxycyclohexyl)ethyltrimethoxysilane, 3-glycidoxypropyl methyldimethoxysilane, 3-glycidoxypropyl trimethoxysilane, 3-glycidoxypropyl methyldiethoxysilane, and 3-glycidoxypropyl triethoxysilane.

It is expected that the silane coupling agent is hydrolyzed so that a silanol group is generated and then the silanol group is bonded to zinc so that the zinc is stabilized in the paint. The silanol group is bonded also to the to-be-coated material composed of metal. Further, the paint component is bridged or chemically bonded through the functional group. As a result, the adhesiveness of the paint film is improved.

From the perspectives of the in-water dispersibility and stability of the paint, the storage stability, and expression of satisfactory adhesiveness in the paint film, the mass ratio of the silane coupling agent to zinc is preferably 0.005 or higher and 1 or lower. The lower limit of the mass ratio is more preferably 0.02 and still more preferably 0.12. Further, the upper limit of the mass ratio is more preferably 0.8 and still more preferably 0.6.

In the water-based anti-corrosive paint, allowed to be added are: a water-soluble solvent; and additives for paint such as a wetting agent, a wetting and dispersing additive, an antifoaming agent, thickener, and a pH adjuster. Employable water-soluble solvents include a glycol solvent such as propylene glycol and ethylene glycol, an alcoholic solvent such as ethanol and isopropanol, and a glycol ether solvent such as dipropylene glycol monomethyl ether.

Employable additives for paint include: a wetting and dispersing additive composed of polycarboxylic acid or the like; a wetting agent composed of organic phosphate ester, diester sulfosuccinate such as sodium bistridecyl sulfosuccinate, or the like; an antifoaming agent composed of a silicone or acrylic substance; and a thickener composed of an ether of hydroxyethylcellulose, methylcellulose, methyl hydroxypropylcellulose, ethyl hydroxyethylcellulose, or methylethylcellulose, and a mixture of these substances.

The water-based anti-corrosive paint is applied on the Zn—Al—Mg alloy coating layer by dipping treatment such as immersion drain (dip drain) and immersion rotation (dip spin), by brushing, by spraying, or by another method.

It is preferable that the paint of the present invention is baked at 180 degrees C. or lower for 30 to 40 minutes. In this case, hardness degradation does not occur in the chain constituent components and hence degradation in the chain strength and in the chain lifetime is suppressed.

The paint of the present invention may be applied plural times onto the Zn—Al—Mg alloy coating layer.

From the perspectives of expression of satisfactory corrosion resistance and the cost, it is preferable that the coating is performed such that the amount of application may become 5 mg/dm² to 400 mg/dm² and the total film thickness of the paint films may become 1 μm to 30 μm. Then, in a case that the first paint film and a second paint film (a paint film formed on the first paint film by using the paint) are formed on the to-be-coated material, it is preferable that the total film thickness of the two paint films is 5 to 30 μm and the amount of application is 50/dm² to 400 mg/dm².

The water-based anti-corrosive paint fabricated as described above has satisfactory storage stability. Then, in the chain of the present invention in which the Zn—Al—Mg alloy coating layer is formed on the surface of the iron-based basis material and then a paint film is formed on the Zn—Al—Mg alloy coating layer by employing the water-based anti-corrosive paint, the adhesiveness of the paint film is satisfactory and the rust prevention property is maintained satisfactorily for a long period of time.

### EXAMPLES

Examples and comparison examples of the present invention are described below in detail. However, the present invention is not limited to these examples.

### 1. Evaluation of Rust Prevention Property of Chain

### Blend Examples 1 to 37

In accordance with the blending quantity (expressed in mass part) in the following Tables 1 to 3, blended were: zinc flake (“STANDART (registered tradename) ZINC FLAKE AT” fabricated by ECKART); precipitated barium sulfate (“B-35” fabricated by Sakai Chemical Industry Co., Ltd.); colloidal silica (“PL-3-D” fabricated by Fuso Chemical Co., Ltd.); polyoxyethylene alkyl ether; n-hexyl trimethoxysilane; a wetting and dispersing additive; a polyol compound; a polyisocyanate compound; water; propylene glycol; a silicone-based antifoaming agent (“BYK018” fabricated by BYK Japan KK); and a wetting agent. By this method, the paint of Blend Examples 1 to 37 was obtained.

TABLE 1

| | Blend | Blend | Blend | Blend | Blend | Blend | Blend | Blend | Blend | Blend | Blend | Blend | Blend | Blend | Blend |
|---|---|---|---|---|---|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 | Ex. 10 | Ex. 11 | Ex. 12 | Ex. 13 | Ex. 14 | Ex. 15 |
| Zinc Flake | 25 | 25 | 25 | 25 | 25 | 20 | 20 | 20 | 20 | 20 | 15 | 15 | 15 | 15 | 15 |
| Precipitated Barium Sulfate | 0 | 0 | 0 | 0 | 0 | 5 | 5 | 5 | 5 | 5 | 10 | 10 | 10 | 10 | 10 |
| Colloidal Silica | 0 | 3 | 5 | 7 | 10 | 0 | 3 | 5 | 7 | 10 | 0 | 3 | 5 | 7 | 10 |
| Polyoxyethylene Alkyl | 1 | 1 | 1 | 1 | 1 | 0.8 | 0.8 | 0.8 | 0.8 | 0.8 | 0.6 | 0.6 | 0.6 | 0.6 | 0.6 |
| Ether | | | | | | | | | | | | | | | |
| n-Hexyl Trimethoxysilane | 1 | 1 | 1 | 1 | 1 | 0.8 | 0.8 | 0.8 | 0.8 | 0.8 | 0.6 | 0.6 | 0.6 | 0.6 | 0.6 |
| Wetting and Dispersing | 3 | 3 | 3 | 3 | 3 | 2.9 | 2.9 | 2.9 | 2.9 | 2.9 | 2.8 | 2.8 | 2.8 | 2.8 | 2.8 |
| Additive | | | | | | | | | | | | | | | |
| Polyol Compound | 32 | 32 | 32 | 32 | 32 | 32 | 32 | 32 | 32 | 32 | 32 | 32 | 32 | 32 | 32 |
| Polyisocyanate Compound | 10 | 10 | 10 | 10 | 10 | 10 | 10 | 10 | 10 | 10 | 10 | 10 | 10 | 10 | 10 |
| Water | 23 | 20 | 18 | 16 | 13 | 23 | 20 | 18 | 17 | 13 | 24 | 21 | 19 | 17 | 14 |
| Propylene Glycol | 5 | 5 | 5 | 5 | 5 | 5 | 5 | 5 | 5 | 5 | 5 | 5 | 5 | 5 | 5 |
| Silicone-based Antifoaming | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Agent | | | | | | | | | | | | | | | |
| Wetting Agent | 0.1 | 0.1 | 0.1 | 0.1 | 0.1 | 0.1 | 0.1. | 0.1 | 0.1 | 0.1 | 0.1 | 0.1 | 0.1 | 0.1 | 0.1 |
| Barium Sulfate/Zinc Flake | 0 | 0 | 0 | 0 | 0 | 0.3 | 0.3 | 0.3 | 0.3 | 0.3 | 0.7 | 0.7 | 0.7 | 0.7 | 0.7 |
| Colloidal Silica/Zinc + | 0% | 2% | 4% | 6% | 8% | 0% | 2% | 4% | 6% | 8% | 0% | 2% | 4% | 6% | 8% |
| Barium Sulfate) | | | | | | | | | | | | | | | |
| PWC | 60% | 60% | 60% | 60% | 61% | 60% | 60% | 60% | 60% | 61% | 60% | 60% | 60% | 60% | 61% |

TABLE 2

| | Blend | Blend | Blend | Blend | Blend | Blend | Blend | Blend | Blend | Blend | Blend | Blend | Blend | Blend | Blend |
|---|---|---|---|---|---|---|---|---|---|---|---|---|---|---|---|
| | Ex. | Ex. | Ex. | Ex. | Ex. | Ex. | Ex. | Ex. | Ex. | Ex. | Ex. | Ex. | Ex. | Ex. | Ex. |
| | 16 | 17 | 18 | 19 | 20 | 21 | 22 | 23 | 24 | 25 | 26 | 27 | 28 | 29 | 30 |
| Zinc Flake | 10 | 10 | 10 | 10 | 10 | 5 | 5 | 5 | 5 | 5 | 4 | 4 | 4 | 4 | 4 |
| Precipitated Barium Sulfate | 15 | 15 | 15 | 15 | 15 | 20 | 20 | 20 | 20 | 20 | 21 | 21 | 21 | 21 | 21 |
| Colloidal Silica | 0 | 3 | 5 | 7 | 10 | 0 | 3 | 5 | 7 | 10 | 0 | 3 | 5 | 7 | 10 |
| Polyoxyethylene Alkyl Ether | 0.4 | 0.4 | 0.4 | 0.4 | 0.4 | 0.2 | 0.2 | 0.2 | 0.2 | 0.2 | 0.2 | 0.2 | 0.2 | 0.2 | 0.2 |
| n-Hexyl Trimethoxysilane | 0.4 | 0.4 | 0.4 | 0.4 | 0.4 | 0.2 | 0.2 | 0.2 | 0.2 | 0.2 | 0.2 | 0.2 | 0.2 | 0.2 | 0.2 |
| Wetting and Dispersing Additive | 2.7 | 2.7 | 2.7 | 2.7 | 2.7 | 2.6 | 2.6 | 2.6 | 2.6 | 2.6 | 2.6 | 2.6 | 2.6 | 2.6 | 2.6 |
| Polyol Compound | 32 | 32 | 32 | 32 | 32 | 32 | 32 | 32 | 32 | 32 | 32 | 32 | 32 | 32 | 32 |
| Polyisocyanate Compound | 10 | 10 | 10 | 10 | 10 | 10 | 10 | 10 | 10 | 10 | 10 | 10 | 10 | 10 | 10 |
| Water | 24 | 21 | 19 | 17 | 14 | 25 | 22 | 20 | 18 | 15 | 25 | 25 | 25 | 25 | 25 |
| Propylene Glycol | 5 | 5 | 5 | 5 | 5 | 5 | 5 | 5 | 5 | 5 | 5 | 5 | 5 | 5 | 5 |
| Silicone-based Antifoaming Agent | 0.1 | 0.1 | 0.1 | 0.1 | 0.1 | 0.1. | 0.1 | 0.1 | 0.1 | 0.1 | 0.1 | 0.1 | 0.1 | 0.1 | 0.1 |
| Wetting Agent | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| Barium Sulfate/Zinc Flake | 1.5 | 1.5 | 1.5 | 1.5 | 1.5 | 4.0 | 4.0 | 4.0 | 4.0 | 4.0 | 5.3 | 5.3 | 5.3 | 5.3 | 5.3 |
| Colloidal Silica/(Zinc + Barium Sulfate) | 0% | 2% | 4% | 6% | 8% | 0% | 2% | 4% | 6% | 8% | 0% | 2% | 4% | 6% | 8% |
| PWC | 60% | 60% | 60% | 60% | 61% | 60% | 60% | 60% | 60% | 61% | 60% | 60% | 61% | 61% | 61% |

TABLE 3

| | Blend | Blend | Blend | Blend | Blend | Blend | Blend |
|---|---|---|---|---|---|---|---|
| | Ex. 31 | Ex. 32 | Ex. 33 | Ex. 34 | Ex. 35 | Ex. 36 | Ex. 37 |
| Zinc Flake | 3 | 1 | 15.5 | 12.4 | 8.2 | 6.7 | 5.5 |
| Precipitated Barium Sulfate | 22 | 24 | 23.5 | 18.6 | 12.3 | 10.0 | 8.2 |
| Colloidal Silica | 0 | 0 | 4.7 | 3.7 | 2.5 | 2.0 | 1.7 |
| Polyoxyethylene Alkyl Ether | 0.2 | 0.2 | 0.5 | 0.4 | 0.3 | 0.3 | 0.2 |
| n-Hexyl Trimethoxysilane | 0.2 | 0.2 | 0.5 | 0.4 | 0.3 | 0.3 | 0.2 |
| Wetting and Dispersing Additive | 2.6 | 2.6 | 3.6 | 3.0 | 2.3 | 2.0 | 1.7 |
| Polyol Compound | 32 | 32 | 32 | 32 | 32 | 32 | 32 |
| Polyisocyanate Compound | 10.3 | 10.3 | 10.3 | 10.3 | 10.3 | 10.3 | 10.3 |
| Water | 24.5 | 24.5 | 4.3 | 14.0 | 26.6 | 31.2 | 35.0 |
| Propylene Glycol | 5 | 5 | 5 | 5 | 5 | 5 | 5 |
| Silicone-based Antifoaming Agent | 0.1 | 0.1 | 0.1 | 0.1 | 0.1 | 0.1 | 0.1 |
| Wetting Agent | 0.1 | 0.1 | 0.1 | 0.1 | 0.1 | 0.1 | 0.1 |
| Barium Sulfate/Zinc Flake | 7.3 | 24.0 | 1.5 | 1.5 | 1.5 | 1.5 | 1.5 |
| Colloidal Silica/(Zinc + Barium Sulfate) | 0% | 0% | 2% | 2% | 2% | 2% | 2% |
| PWC | 60% | 60% | 70% | 65% | 55% | 50% | 45% |

Tables 1 to 3 list precipitated barium sulfate/zinc flake (expressed as BaSO₄/Zn, hereinafter), [(solid content of colloidal silica)]/[zinc flake+precipitated barium sulfate] [%] [expressed as colloidal silica/(zinc+barium sulfate) in the tables], and PWC (Pigment Weight Concentration) [%].

The PWC is expressed by the mass ratio between [zinc flake+(precipitated barium sulfate) and/or (solid content of colloidal silica)] and [zinc flake+(precipitated barium sulfate) and/or (solid content of colloidal silica)+(the mass of the hardened material after the resin has been hardened (the mass of the solid content of the resin))] in the inside of the paint film having been formed.

### Example 1

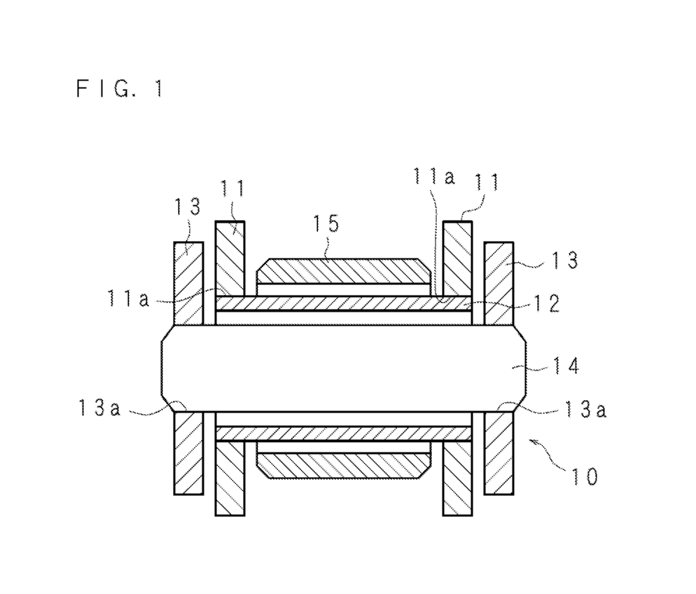

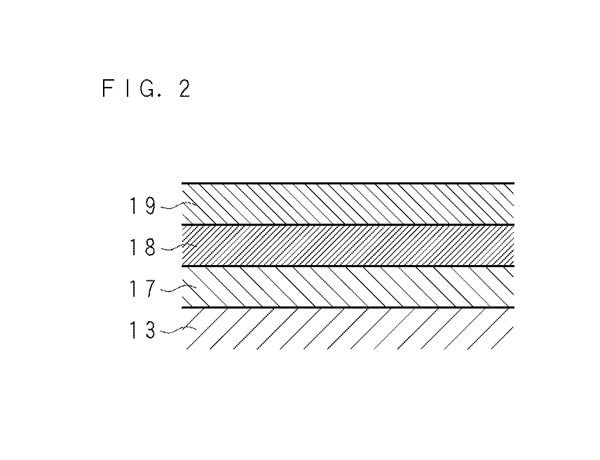

FIG. 1 is a sectional view illustrating a chain 10 according to Example 1. FIG. 2 is an enlarged sectional view illustrating the surface of a part of a chain of FIG. 1.

As illustrated in FIGS. 1 and 2, the chain 10 includes: a pair of right and left inner plates 11 and 11 arranged in a manner of being separated from each other; a bush 12 press-fit into bush press-fitting holes 11a and 11a of the inner plates 11 and 11; a pair of right and left outer plates 13 and 13 arranged on the outer sides of the inner plates 11 and 11 and linked to the inner plates 11 and 11 in the forward and rearward directions; a connecting pin 14 loosely fit to the inner peripheral surface of the bush 12 and press-fit into pin press-fitting holes 13a and 13a of the outer plates 13 and 13; and a roller 15 loosely fit to the outer peripheral surface of the bush 12.

The surface of each of the inner plate 11, the bush 12, the outer plate 13, the connecting pin 14, and the roller 15 is provided with: a Zn—Al—Mg alloy coating layer 17; a first paint film 18 formed by employing the water-based anti-corrosive paint; and a second paint film 19 formed by employing the water-based anti-corrosive paint. FIG. 2 illustrates a situation that the Zn—Al—Mg alloy coating layer 17, the first paint film 18, and the second paint film 19 are stacked on the surface of the outer plate 13.

A blasting material composed of Zn—Al—Mg alloy (“ZR#50S” fabricated by Dowa IP Creation Co., Ltd.) was projected onto the surface of the constituent component (the inner plate 11, the bush 12, the outer plate 13, the connecting pin 14, or the roller 15) of the chain 10 so that the Zn—Al—Mg alloy coating layer 17 was formed. Then, the water-based anti-corrosive paint of Blend Example 3 of Table 1 given above was applied on the surface of the Zn—Al—Mg alloy coating layer 17 by a dip spin method and then baked at 180 degrees C. for 40 minutes so that the first paint film 18 having a thickness of 5 μm was formed. Further, the water-based anti-corrosive paint of Blend Example 3 was applied on the surface of the first paint film 18 by a dip spin method and then baked at 180 degrees C. for 40 minutes so that the second paint film 19 having a thickness of 3 μm was formed.

By this method, the chain 10 according to Example 1 was obtained. The configurations of the coating layer and the paint film are listed in the following Table 4. In the following Table 4, the “first coating layer” indicates the Zn—Al—Mg alloy coating layer.

TABLE 4

| | Ex. 1 | Ex. 2 | Ex. 3 | Ex. 4 | Ex. 5 | Ex. 6 | Ex. 7 | Ex. 8 |
|---|---|---|---|---|---|---|---|---|
| Underlayer Treatment | 1st | 1st | 1st | 1st | 1st | 1st | 1st | 1st |
| | Coating | Coating | Coating | Coating | Coating | Coating | Coating | Coating |
| | Layer | Layer | Layer | Layer | Layer | Layer | Layer | Layer |
| 1st Paint Film | Blend | Blend | Blend | Blend | Blend | Blend | Blend | Blend |
| | Ex. 3 | Ex. 4 | Ex. 5 | Ex. 7 | Ex. 8 | Ex. 9 | Ex. 10 | Ex. 12 |
| 2nd Paint Film | Blend | Blend | Blend | Blend | Blend | Blend | Blend | Blend |
| | Ex. 3 | Ex. 4 | Ex. 5 | Ex. 7 | Ex. 8 | Ex. 9 | Ex. 10 | Ex. 12 |
| Concealment Property | ◯ | ◯ | ◯ | ◯ | ◯ | ◯ | ◯ | ◯ |
| Rust Prevention Property | 500 h | 700 h | 700 h | 700 h | 1000 h | 1000 h | 1000 h | 700 h |
| | Ex. 9 | Ex. 10 | Ex. 11 | Ex. 12 | Ex. 13 | Ex. 14 | Ex. 15 | Ex. 16 |
| Underlayer Treatment | 1st | 1st | 1st | 1st | 1st | 1st | 1st | 1st |
| | Coating | Coating | Coating | Coating | Coating | Coating | Coating | Coating |
| | Layer | Layer | Layer | Layer | Layer | Layer | Layer | Layer |
| 1st Paint Film | Blend | Blend | Blend | Blend | Blend | Blend | Blend | Blend |
| | Ex. 13 | Ex. 14 | Ex. 15 | Ex. 16 | Ex. 17 | Ex. 18 | Ex. 19 | Ex. 20 |
| 2nd Paint Film | Blend | Blend | Blend | Blend | Blend | Blend | Blend | Blend |
| | Ex. 13 | Ex. 14 | Ex. 15 | Ex. 16 | Ex. 17 | Ex. 18 | Ex. 19 | Ex. 20 |
| Concealment Property | ◯ | ◯ | ◯ | ◯ | ◯ | ◯ | ◯ | ◯ |
| Rust Prevention Property | 1000 h | 1000 h | 1000 h | 1000 h | 1000 h | 1000 h | 1500 h | 1500 h |
| | Ex. 17 | Ex. 18 | Ex. 19 | Ex. 20 | Ex. 21 | Ex. 22 | Ex. 23 | Ex. 24 |
| Underlayer Treatment | 1st | 1st | 1st | 1st | 1st | 1st | 1st | 1st |
| | Coating | Coating | Coating | Coating | Coating | Coating | Coating | Coating |
| | Layer | Layer | Layer | Layer | Layer | Layer | Layer | Layer |
| 1st Paint Film | Blend | Blend | Blend | Blend | Blend | Blend | Blend | Blend |
| | Ex. 21 | Ex. 22 | Ex. 23 | Ex. 24 | Ex. 25 | Ex. 26 | Ex. 27 | Ex. 28 |
| 2nd Paint Film | Blend | Blend | Blend | Blend | Blend | Blend | Blend | Blend |
| | Ex. 21 | Ex. 22 | Ex. 23 | Ex. 24 | Ex. 25 | Ex. 26 | Ex. 27 | Ex. 28 |
| Concealment Property | ◯ | ◯ | ◯ | ◯ | ◯ | ◯ | ◯ | ◯ |
| Rust Prevention Property | 700 h | 1000 h | 1000 h | 1500 h | 1500 h | 700 h | 1000 h | 1000 h |

### Example 2 to 31

Similarly to Example 1, the coating layer having the configurations listed in Table 4 given above and Table 5 given below were formed so that the chain of each of Examples 2 to 31 was fabricated.

TABLE 5

| | Ex. 25 | Ex. 26 | Ex. 27 | Ex. 28 | Ex. 29 | Ex. 30 | Ex. 31 |
|---|---|---|---|---|---|---|---|
| Underlayer Treatment | 1st | 1st | 1st | 1st | 1st | 1st | 1st |
| | Coating | Coating | Coating | Coating | Coating | Coating | Coating |
| | Layer | Layer | Layer | Layer | Layer | Layer | Layer |
| 1st Paint Film | Blend | Blend | Blend | Blend | Blend | Blend | Blend |
| | Ex. 29 | Ex. 30 | Ex. 33 | Ex. 34 | Ex. 35 | Ex. 36 | Ex. 37 |
| 2nd Paint Film | Blend | Blend | Blend | Blend | Blend | Blend | Blend |
| | Ex. 29 | Ex. 30 | Ex. 33 | Ex. 34 | Ex. 35 | Ex. 36 | Ex. 37 |
| Concealment Property | ◯ | ◯ | ◯ | ◯ | ◯ | ◯ | ◯ |
| Rust Prevention Property | 1500 h | 1500 h | 1000 h | 1000 h | 1000 h | 700 h | 500 h |

### Comparison Examples 1 to 37

A blasting material composed of Zn—Fe alloy was projected onto the surface of the chain so that the Zn—Fe alloy coating layer was formed. Then, the water-based anti-corrosive paint of each blend example listed in Tables 6 and 7 given below was applied twice on the Zn—Fe alloy coating layer so that the chain of each of Comparison Examples 1 to 37 was fabricated. In Tables 6 and 7, the “second coating layer” indicates the Zn—Fe alloy coating layer.

TABLE 6

| | Comp. | Comp. | Comp. | Comp. | Comp. | Comp. | Comp. | Comp. | Comp. |
|---|---|---|---|---|---|---|---|---|---|
| | Ex. 1 | Ex. 2 | Ex. 3 | Ex. 4 | Ex. 5 | Ex. 6 | Ex. 7 | Ex. 8 | Ex. 9 |
| Underlayer Treatment | 2nd | 2nd | 2nd | 2nd | 2nd | 2nd | 2nd | 2nd | 2nd |
| | Coating | Coating | Coating | Coating | Coating | Coating | Coating | Coating | Coating |
| | Layer | Layer | Layer | Layer | Layer | Layer | Layer | Layer | Layer |
| 1st Paint Film | Blend | Blend | Blend | Blend | Blend | Blend | Blend | Blend | Blend |
| | Ex. 1 | Ex. 2 | Ex. 3 | Ex. 4 | Ex. 5 | Ex. 6 | Ex. 7 | Ex. 8 | Ex. 9 |
| 2nd Paint Film | Blend | Blend | Blend | Blend | Blend | Blend | Blend | Blend | Blend |
| | Ex. 1 | Ex. 2 | Ex. 3 | Ex. 4 | Ex. 5 | Ex. 6 | Ex. 7 | Ex. 8 | Ex. 9 |
| Concealment Property | ◯ | ◯ | ◯ | ◯ | ◯ | ◯ | ◯ | ◯ | ◯ |
| Rust Prevention Property | 100 h | 100 h | 200 h | 300 h | 300 h | 100 h | 200 h | 300 h | 300 h |
| | Comp. | Comp. | Comp. | Comp. | Comp. | Comp. | Comp. | Comp. | Comp. |
| | Ex. 10 | Ex. 11 | Ex. 12 | Ex. 13 | Ex. 14 | Ex. 15 | Ex. 16 | Ex. 17 | Ex. 18 |
| Underlayer Treatment | 2nd | 2nd | 2nd | 2nd | 2nd | 2nd | 2nd | 2nd | 2nd |
| | Coating | Coating | Coating | Coating | Coating | Coating | Coating | Coating | Coating |
| | Layer | Layer | Layer | Layer | Layer | Layer | Layer | Layer | Layer |
| 1st Paint Film | Blend | Blend | Blend | Blend | Blend | Blend | Blend | Blend | Blend |
| | Ex. 10 | Ex. 11 | Ex. 12 | Ex. 13 | Ex. 14 | Ex. 15 | Ex. 16 | Ex. 17 | Ex. 18 |
| 2nd Paint Film | Blend | Blend | Blend | Blend | Blend | Blend | Blend | Blend | Blend |
| | Ex. 10 | Ex. 11 | Ex. 12 | Ex. 13 | Ex. 14 | Ex. 15 | Ex. 16 | Ex. 17 | Ex. 18 |
| Concealment Property | ◯ | ◯ | ◯ | ◯ | ◯ | ◯ | ◯ | ◯ | ◯ |
| Rust Prevention Property | 300 h | 100 h | 200 h | 300 h | 300 h | 300 h | 100 h | 100 h | 300 h |

| | Comp. | Comp. | Comp. | Comp. | Comp. | Comp. | Comp. | Comp. |
|---|---|---|---|---|---|---|---|---|
| | Ex. 19 | Ex. 20 | Ex. 21 | Ex. 22 | Ex. 23 | Ex. 24 | Ex. 25 | Ex. 26 |
| Underlayer Treatment | 2nd | 2nd | 2nd | 2nd | 2nd | 2nd | 2nd | 2nd |
| | Coating | Coating | Coating | Coating | Coating | Coating | Coating | Coating |
| | Layer | Layer | Layer | Layer | Layer | Layer | Layer | Layer |
| 1st Paint Film | Blend | Blend | Blend | Blend | Blend | Blend | Blend | Blend |
| | Ex. 19 | Ex. 20 | Ex. 21 | Ex. 22 | Ex. 23 | Ex. 24 | Ex. 25 | Ex. 26 |
| 2nd Paint Film | Blend | Blend | Blend | Blend | Blend | Blend | Blend | Blend |
| | Ex. 19 | Ex. 20 | Ex. 21 | Ex. 22 | Ex. 23 | Ex. 24 | Ex. 25 | Ex. 26 |
| Concealment Property | ◯ | ◯ | ◯ | ◯ | ◯ | ◯ | ◯ | ◯ |
| Rust Prevention Property | 300 h | 300 h | 200 h | 300 h | 300 h | 300 h | 300 h | 200 h |

TABLE 7

| | Comp. | Comp. | Comp. | Comp. | Comp. | Comp. | Comp. |
|---|---|---|---|---|---|---|---|
| | Ex. 27 | Ex. 28 | Ex. 29 | Ex. 30 | Ex. 31 | Ex. 32 | Ex. 33 |
| Underlayer Treatment | 2nd | 2nd | 2nd | 2nd | 2nd | 2nd | 2nd |
| | Coating | Coating | Coating | Coating | Coating | Coating | Coating |
| | Layer | Layer | Layer | Layer | Layer | Layer | Layer |
| 1st Paint Film | Blend | Blend | Blend | Blend | Blend | Blend | Blend |
| | Ex. 27 | Ex. 28 | Ex. 29 | Ex. 30 | Ex. 31 | Ex. 32 | Ex. 33 |
| 2nd Paint Film | Blend | Blend | Blend | Blend | Blend | Blend | Blend |
| | Ex. 27 | Ex. 28 | Ex. 29 | Ex. 30 | Ex. 31 | Ex. 32 | Ex. 33 |
| Concealment Property | ◯ | ◯ | ◯ | ◯ | Δ | X | ◯ |
| Rust Prevention Property | 300 h | 300 h | 300 h | 300 h | — | — | 300 h |
| | Comp. | Comp. | Comp. | Comp. | Comp. | Comp. | Comp. |
| | Ex. 34 | Ex. 35 | Ex. 36 | Ex. 37 | Ex. 38 | Ex. 39 | Ex. 40 |
| Underlayer Treatment | 2nd | 2nd | 2nd | 2nd | 1st | 1st | 1st |
| | Coating | Coating | Coating | Coating | Coating | Coating | Coating |
| | Layer | Layer | Layer | Layer | Layer | Layer | Layer |
| 1st Paint Film | Blend | Blend | Blend | Blend | Blend | Blend | Blend |
| | Ex. 34 | Ex. 35 | Ex. 36 | Ex. 37 | Ex. 1 | Ex. 2 | Ex. 6 |
| 2nd Paint Film | Blend | Blend | Blend | Blend | Blend | Blend | Blend |
| | Ex. 34 | Ex. 35 | Ex. 36 | Ex. 37 | Ex. 1 | Ex. 2 | Ex. 6 |
| Concealment Property | ◯ | ◯ | ◯ | ◯ | ◯ | ◯ | ◯ |
| Rust Prevention Property | 300 h | 300 h | 300 h | 200 h | 300 h | 300 h | 300 h |

| | Comp. | Comp. | Comp. | Comp. | Comp. | Comp. |
|---|---|---|---|---|---|---|
| | Ex. 41 | Ex. 42 | Ex. 43 | Ex. 44 | Ex. 45 | Ex. 46 |
| Underlayer Treatment | 1st | 1st | 1st | — | 2nd | 1st |
| | Coating | Coating | Coating | — | Coating | Coating |
| | Layer | Layer | Layer | — | Layer | Layer |
| 1st Paint Film | Blend | Blend | Blend | — | — | — |
| | Ex. 11 | Ex. 31 | Ex. 32 | | | |
| 2nd Paint Film | Blend | Blend | Blend | — | — | — |
| | Ex. 11 | Ex. 31 | Ex. 32 | | | |
| Concealment Property | ◯ | Δ | X | — | — | — |
| Rust Prevention Property | 300 h | — | — | 20 h | 40 h | 300 h |

### Comparison Examples 38 to 43

The Zn—Al—Mg alloy coating layer (the first coating layer) was formed on the surface of the chain and then the water-based anti-corrosive paint of each blend example listed in Table 7 above was applied twice on the first coating layer so that the chain of each of Comparison Examples 38 to 43 was fabricated.

### Comparison Example 44

In the chain of Comparison Example 44, the surface is not provided with the coating layer.

### Comparison Example 45

The Zn—Fe alloy coating layer was formed on the surface of the chain. No paint film was formed.

### Comparison Example 46

The Zn—Al—Mg alloy coating layer was formed on the surface of the chain. No paint film was formed.

Evaluation of the concealment property and the rust prevention property was performed on the chains of the examples and the comparison examples. The evaluation method was as follows.

[Evaluation of Concealment Property]

Whether the underlying coating layer was visually seen was evaluated by visual inspection. Evaluation was as follows.

◯ . . . Underlying layer is not transparent

Δ . . . Underlying layer is somewhat transparent

x . . . Underlying layer is transparent

[Salt Spray Test (Rust Prevention Property Evaluation Test)]

The chains of Examples and Comparison Examples were subjected to salt spray tests. The test was carried out according to JIS-K5600-7-1. A time when red rust visually appears at the tacked portion of the outer plate 13 and the connecting pin 14 and on the surface of the outer plate 13 was measured. These results were shown in Tables 4 to 7 above.

As described above, in the chain of each of Examples 1 to 31, the Zn—Al—Mg alloy coating layer has been formed as an underlying coating layer. Further, in the chain of each of Comparison Examples 1 to 37, the Zn—Fe alloy coating layer has been formed as an underlying coating layer. As seen from Tables 4 to 7, in a case that the paint film employing the same water-based anti-corrosive paint is formed on the underlying coating layer, the rust prevention property is remarkably improved in the chain of example than in the chain of comparison example.

As seen from Comparison Examples 44 to 46, in a case that the alloy coating layer and the paint film are not formed or, alternatively, in a case that the first coating layer or the second coating layer is formed but the paint film is not formed, the rust prevention property is remarkably unsatisfactory.

In a case that the water-based anti-corrosive paint contains BaSO₄ and colloidal silica, the rust prevention property is remarkably satisfactory.

In that case, it is preferable that the mass ratio of BaSO₄/Zn is 0.15 or higher. The lower limit of BaSO₄/Zn is more preferably 0.3, still more preferably 0.7, remarkably preferably 1.1, and most preferably 1.5. Comparison Examples 42 and 43 infer that, when BaSO₄/Zn exceeds 7, the concealment property is somewhat degraded. Thus, it is preferable that the upper limit of BaSO₄/Zn is 7.

In the case that the water-based anti-corrosive paint contains BaSO₄ and colloidal silica, it is preferable that (solid content of colloidal silica)/(Zn+BaSO₄) is 0.01 (1%) or higher. When (solid content of colloidal silica)/(Zn+BaSO₄) exceeds 8%, it has been recognized that the adhesiveness is somewhat degraded. Thus, it is preferable that (solid content of colloidal silica)/(Zn+BaSO₄) is 1% or higher and 8% or lower. The lower limit of (solid content of colloidal silica)/(Zn+BaSO₄) is more preferably 2%, still more preferably 3%, remarkably preferably 4%, and most preferably 5%.

The water-based anti-corrosive paint may contain colloidal silica alone of barium sulfate and colloidal silica. By comparing Examples 1 and 2 with Comparison Examples 38 and 39, it is confirmed that when (solid content of colloidal silica)/(Zn) is 4% or higher and 8% or lower, the rust prevention property is satisfactory. The lower limit of (solid content of colloidal silica)/(Zn) is more preferably 5%, and still more preferably 6%.

The water-based anti-corrosive paint may contain barium sulfate alone of barium sulfate and colloidal silica. By comparing Example 12 with Comparison Examples 40 to 43, it is confirmed that when BaSO₄/Zn is 1.1 or higher and 7 or lower, the concealment property is satisfactory and the rust prevention property is satisfactory. The lower limit of BaSO₄/Zn is more preferably 1.5.

Further, in Example 31 where the PWC is 45%, the rust prevention property is satisfactory. When the PWC exceeds 70%, it has been recognized that the adhesiveness is somewhat degraded. Thus, it is preferable that the PWC is 45% or higher and 70% or lower. The lower limit of the PWC is more preferably 48%, still more preferably 50%, remarkably preferably 53%, and most preferably 55%.

As recognized from the description given above, the chain according to the examples of the present invention has the satisfactory adhesiveness and concealment property of the paint film. Further, the rust prevention property is maintained satisfactorily.

### 2. Evaluation of in-Water Stability of the Water-Based Anti-Corrosive Paint

The following description is given for the results of evaluation of in-water stability of the water-based anti-corrosive paint employed in the paint film of the chain of the present invention in a case that the blending quantity of the silane compound, the surfactant, and the silane coupling agent was changed.

### Blend Examples A to G

In accordance with the blending quantity (expressed in mass part) in the following Table 8, blended were: zinc flake (“STANDART (registered tradename) ZINC FLAKE AT”); polyoxyethylene alkyl ether serving as a surfactant; n-hexyl trimethoxysilane serving as a silane compound; a wetting and dispersing additive; and water. By this method, the paint of each of Blend Examples A to G was obtained.

TABLE 8

| | Blend | Blend | Blend | Blend | Blend | Blend | Blend |
|---|---|---|---|---|---|---|---|
| | Ex. A | Ex. B | Ex. C | Ex. D | Ex. E | Ex. F | Ex. G |
| Water | 70.0 | 69.0 | 65.0 | 61.0 | 51.0 | 41.0 | 31.0 |
| Polyoxyethylene Alkyl | 0.5 | 1.0 | 3.0 | 5.0 | 10.0 | 15.0 | 20.0 |
| Ether | | | | | | | |
| n-Hexyl | 0.5 | 1.0 | 3.0 | 5.0 | 10.0 | 15.0 | 20.0 |
| Trimethoxysilane | | | | | | | |
| Zinc Flake | 25.0 | 25.0 | 25.0 | 25.0 | 25.0 | 25.0 | 25.0 |
| Wetting and | 4.0 | 4.0 | 4.0 | 4.0 | 4.0 | 4.0 | 4.0 |
| Dispersing Additive | | | | | | | |
| Surfactant/Zinc [%] | 2% | 4% | 12% | 20% | 40% | 60% | 80% |
| Silane Compound/Zinc | 2% | 4% | 12% | 20% | 40% | 60% | 80% |
| [%] | | | | | | | |
| In-Water Stability | Δ | Δ | Δ | Δ | Δ | Δ | Δ |
| Storage Stability | Δ | ◯ | ◯ | ◯ | ◯ | ◯ | Δ |
| Comprehensive | Δ | ◯ | ◯ | ◯ | ◯ | ◯ | Δ |
| Evaluation | | | | | | | |

Table 8 lists: polyoxyethylene alkyl ether (surfactant)/zinc [%]; n-hexyl trimethoxysilane (silane compound)/zinc [%]; and the results of evaluation of the in-water stability and the storage stability.

As for the in-water stability, the paint was prepared and then left at room temperature for three days. Then, the presence or absence of gas generation was checked. Evaluation was as follows.

◯: Without gas generation

Δ: Very slight gas generation

x: With gas generation

As for the storage stability, the paint was left at 40 degrees C. The following evaluation was employed.

◯: Gelling in 3 days

Δ: Gelling in 1 day

x: Gelling in 3 hours

-: Not evaluated

### Blend Examples H to L

In accordance with the blending quantity (expressed in mass part) of the following Table 9, blended were: zinc flake “STANDART (registered tradename) ZINC FLAKE AT”, polyoxyethylene alkyl ether serving as a surfactant, n-hexyl trimethoxysilane serving as a silane compound, a wetting and dispersing additive, 3-glycidoxypropyl trimethoxysilane serving as a silane coupling agent, acetic acid, and water. By this method, the paint of each of Blend Examples H to L was obtained.

TABLE 9

| | Blend | Blend | Blend | Blend | Blend |
|---|---|---|---|---|---|
| | Ex. H | Ex. I | Ex. J | Ex. K | Ex. L |
| Water | 62.0 | 49.0 | 50.0 | 45.0 | 40.0 |
| Polyoxyethylene Alkyl Ether | 3.0 | 3.0 | 3.0 | 3.0 | 3.0 |
| n-Hexyl Trimethoxysilane | 3.0 | 3.0 | 3.0 | 3.0 | 3.0 |
| Zinc Flake | 25.0 | 25.0 | 25.0 | 25.0 | 25.0 |
| Wetting and Dispersing Additive | 4.0 | 4.0 | 4.0 | 4.0 | 4.0 |
| 3-Glycidoxypropyl Trimethoxysilane | 3.0 | 6.0 | 15.0 | 20.0 | 25.0 |
| Acetic Acid | 0.01 | 0.01 | 0.01 | 0.01 | 0.01 |
| Surfactant/Zinc [%] | 12% | 12% | 12% | 12% | 12% |
| Silane Compound/Zinc [%] | 12% | 12% | 12% | 12% | 12% |
| Silane Coupling Agent/Zinc [%] | 12% | 24% | 60% | 80% | 100% |
| In-Water Stability | ◯ | ◯ | ◯ | ◯ | ◯ |
| Storage Stability | ◯ | ◯ | ◯ | Δ | X |
| Comprehensive Evaluation | ⊚ | ⊚ | ⊚ | ◯ | Δ |

Table 9 lists: polyoxyethylene alkyl ether (surfactant)/zinc [%]; n-hexyl trimethoxysilane (silane compound)/zinc [%]; 3-glycidoxypropyl trimethoxysilane (silane coupling agent)/zinc [%]; and the results of evaluation of the in-water stability and the storage stability.

### Blend Examples M, N, P, Q, and R

In accordance with the blending quantity (expressed in mass part) in the following Table 10, blended were: zinc flake (“STANDART (registered tradename) ZINC FLAKE AT”); polyoxyethylene alkyl ether serving as a surfactant; n-hexyl trimethoxysilane serving as a silane compound; a wetting and dispersing additive; and water. By this method, the paint of each of Blend Examples M, N, P, Q, and R was obtained.

TABLE 10

| | Blend | Blend | Blend | Blend | Blend |
|---|---|---|---|---|---|
| | Ex. M | Ex. N | Ex. P | Ex. Q | Ex. R |
| Water | 15.0 | 15.0 | 15.0 | 15.0 | 21.0 |
| Polyoxyethylene Alkyl Ether | | 2.4 | | 0.1 | 25.0 |
| n-Hexyl Trimethoxysilane | | | 2.4 | 0.1 | 25.0 |
| Zinc Flake | 24.0 | 24.0 | 24.0 | 25.0 | 25.0 |
| Wetting and Dispersing Additive | | | | 4.0 | 4.0 |
| Surfactant/Zinc [%] | 0% | 10% | 0% | 0.4% | 100% |
| Silane Compound/Zinc [%] | 0% | 0% | 10% | 0.4% | 100% |
| In-Water Stability | X | X | X | X | X |
| Storage Stability | — | — | — | — | — |
| Comprehensive Evaluation | X | X | X | X | X |

Similarly to Table 8, Table 10 lists: polyoxyethylene alkyl ether (surfactant)/zinc [%]; n-hexyl trimethoxysilane (silane compound)/zinc [%]; and the results of evaluation of the in-water stability and the storage stability.

As seen from Blend Examples M, N, P, Q, and R, the in-water stability was unsatisfactory in each of the case that the paint does not contain the surfactant and the silane compound, the case that any one of the surfactant and the silane compound is contained by 10% relative to zinc, the case that the surfactant and the silane compound are contained by 0.4% each relative to zinc, and the case that the surfactant and the silane compound are contained by 100% each relative to zinc.

As seen from comparison between Blend Examples A to G and Blend Examples M, N, P, Q, and R, the in-water stability and the storage stability were satisfactory in a case that both of the mass ratio of the surfactant to zinc and the mass ratio of the silane compound to zinc are 0.5% or higher and 80% or lower. The lower limit for the mass ratio of the surfactant to zinc and the mass ratio of the silane compound to zinc is preferably 2% and more preferably 4%. The upper limit is preferably 60%.

As seen from Blend Examples H to L, when the paint further contains the silane coupling agent, the in-water stability becomes more satisfactory.

As seen from comparison between Blend Examples A to L and Blend Examples M, N, P. Q, and R, it is preferable that the mass ratio of the silane coupling agent to zinc is 0.5% or higher and 100% or lower. The lower limit of the mass ratio is more preferably 2% and still more preferably 12%. Further, the upper limit of the mass ratio is more preferably 80% and still more preferably 60%.

As described above, it has been recognized that when the water-based anti-corrosive paint contains the silane compound and the surfactant or, alternatively, when the water-based anti-corrosive paint contains the silane coupling agent in addition to these, the in-water stability and the storage stability are satisfactory. Then, the zinc bonded to the silanol group is satisfactorily dispersed in the paint. Thus, at the time that the paint is applied on the surface of the chain and then baked, the paint is easily hardened and, further, a paint film is allowed to be uniformly formed on the to-be-coated material. Thus, it is expected that in a case that the chain is fabricated from an iron-based material, the sacrificial protection action of zinc is uniformly obtained in the plane directions of the paint film and, further, the rust prevention property of the chain becomes more satisfactory.

The embodiment disclosed above is to be recognized as illustrative and not restrictive at all points. The scope of the present invention is not limited to the description given above and is intended to include the contents equivalent to the spirit of the claims and all changes within the scope of the claims.

### DESCRIPTION OF REFERENCE NUMERALS

10 Chain
11 Inner plate
11a Bush press-fitting hole
12 Bush
13 Outer plate
13a Pin press-fitting hole
14 Connecting pin
15 Roller
17 Zn—Al—Mg alloy coating layer
18 First paint film
19 Second paint film

1-11. (canceled)

12. A chain fabricated from an iron-based material, constructed by alternately linking a pair of outer plates and a pair of inner plates, comprising:
a zinc-aluminum-magnesium alloy coating layer formed on a surface; and
a paint film formed on the zinc-aluminum-magnesium alloy coating layer by employing a water-based anti-corrosive paint which contains zinc, barium sulfate and colloidal silica.

13. The chain according to claim 12, wherein a mass ratio of the barium sulfate to the zinc is 0.15 or higher and 7 or lower.

14. The chain according to claim 12, wherein a mass ratio of a solid content of the colloidal silica to a total mass of the zinc and the barium sulfate is 0.01 or higher and 0.08 or lower.

15. The chain according to claim 13, wherein a mass ratio of a solid content of the colloidal silica to a total mass of the zinc and the barium sulfate is 0.01 or higher and 0.08 or lower.

16. A chain fabricated from an iron-based material, constructed by alternately linking a pair of outer plates and a pair of inner plates, comprising:
a zinc-aluminum-magnesium alloy coating layer formed on a surface; and
a paint film formed on the zinc-aluminum-magnesium alloy coating layer by employing a water-based anti-corrosive paint which contains zinc and barium sulfate, and in which a mass ratio of the barium sulfate to the zinc is 1.1 or higher and 7 or lower.

17. A chain fabricated from an iron-based material, constructed by alternately linking a pair of outer plates and a pair of inner plates, comprising:
a zinc-aluminum-magnesium alloy coating layer formed on a surface; and
a paint film formed on the zinc-aluminum-magnesium alloy coating layer by employing a water-based anti-corrosive paint which contains zinc and colloidal silica, and in which a mass ratio of the solid content of the colloidal silica to the zinc is 0.04 or higher and 0.08 or lower.

18. The chain according to claim 12, wherein
the paint film is obtained by at least one kind of resin selected from a group consisting of urethane resin, epoxy resin, and acrylic resin having been hardened, and
a mass ratio of a total mass of the zinc, and the barium sulfate and/or the solid content of the colloidal silica to an entire mass obtained as a sum of the total mass and a mass of a solid content of the resin having been hardened is 0.45 or higher and 0.7 or lower.

19. The chain according to claim 13, wherein
the paint film is obtained by at least one kind of resin selected from a group consisting of urethane resin, epoxy resin, and acrylic resin having been hardened, and
a mass ratio of a total mass of the zinc, and the barium sulfate and/or the solid content of the colloidal silica to an entire mass obtained as a sum of the total mass and a mass of a solid content of the resin having been hardened is 0.45 or higher and 0.7

20. The chain according to claim 14, wherein
the paint film is obtained by at least one kind of resin selected from a group consisting of urethane resin, epoxy resin, and acrylic resin having been hardened, and
a mass ratio of a total mass of the zinc, and the barium sulfate and/or the solid content of the colloidal silica to an entire mass obtained as a sum of the total mass and a mass of a solid content of the resin having been hardened is 0.45 or higher and 0.7

21. The chain according to claim 15, wherein
the paint film is obtained by at least one kind of resin selected from a group consisting of urethane resin, epoxy resin, and acrylic resin having been hardened, and
a mass ratio of a total mass of the zinc, and the barium sulfate and/or the solid content of the colloidal silica to an entire mass obtained as a sum of the total mass and a mass of a solid content of the resin having been hardened is 0.45 or higher and 0.7

22. The chain according to claim 16, wherein
the paint film is obtained by at least one kind of resin selected from a group consisting of urethane resin, epoxy resin, and acrylic resin having been hardened, and
a mass ratio of a total mass of the zinc, and the barium sulfate and/or the solid content of the colloidal silica to an entire mass obtained as a sum of the total mass and a mass of a solid content of the resin having been hardened is 0.45 or higher and 0.7

23. The chain according to claim 17, wherein
the paint film is obtained by at least one kind of resin selected from a group consisting of urethane resin, epoxy resin, and acrylic resin having been hardened, and
a mass ratio of a total mass of the zinc, and the barium sulfate and/or the solid content of the colloidal silica to an entire mass obtained as a sum of the total mass and a mass of a solid content of the resin having been hardened is 0.45 or higher and 0.7

24. The chain according to claim 18, wherein the water-based anti-corrosive paint contains at least one component selected from a group consisting of: a polyisocyanate compound and a polyol compound; urethane resin; epoxy resin and a curing agent; and acrylic resin.

25. The chain according to claim 12, wherein the water-based anti-corrosive paint further contains:
a silane compound whose molecule includes an alkyl group, a phenyl group, or a halo-alkyl group obtained by replacing a part or all of hydrogen atoms with halogen atoms, and a hydrolytic silicon group; and
at least one kind of surfactant selected from a group consisting of polyoxyethylene alkylamine, polyoxyethylene alkyl ether, polyoxyethylene distyrenated phenyl ether, sorbitan fatty acid ester, polyoxyethylene sorbitan fatty acid ester, and alkyl ether phosphate salt.

26. The chain according to claim 16, wherein the water-based anti-corrosive paint further contains:
a silane compound whose molecule includes an alkyl group, a phenyl group, or a halo-alkyl group obtained by replacing a part or all of hydrogen atoms with halogen atoms, and a hydrolytic silicon group; and
at least one kind of surfactant selected from a group consisting of polyoxyethylene alkylamine, polyoxyethylene alkyl ether, polyoxyethylene distyrenated phenyl ether, sorbitan fatty acid ester, polyoxyethylene sorbitan fatty acid ester, and alkyl ether phosphate salt.

27. The chain according to claim 17, wherein the water-based anti-corrosive paint further contains:
a silane compound whose molecule includes an alkyl group, a phenyl group, or a halo-alkyl group obtained by replacing a part or all of hydrogen atoms with halogen atoms, and a hydrolytic silicon group; and
at least one kind of surfactant selected from a group consisting of polyoxyethylene alkylamine, polyoxyethylene alkyl ether, polyoxyethylene distyrenated phenyl ether, sorbitan fatty acid ester, polyoxyethylene sorbitan fatty acid ester, and alkyl ether phosphate salt.

28. The chain according to claim 25, wherein a mass ratio of the silane compound to the zinc is 0.005 or higher and 0.8 or lower.

29. The chain according to claim 25, wherein a mass ratio of the surfactant to the zinc is 0.005 or higher and 0.8 or lower.

30. The chain according to claim 25, wherein the water-based anti-corrosive paint further contains a silane coupling agent whose molecule includes: at least one functional group selected from a group consisting of an epoxy group, a methacryloxy group, an acryloxy group, an amino group, and a vinyl group; and a hydrolytic silicon group.

31. The chain according to claim 30, wherein a mass ratio of the silane coupling agent to the zinc is 0.005 or higher and 1 or lower.
